(19) United States
(12) Patent Application Publication
(10) Pub. No.: US 2016/0359378 A1
(43) Pub. Date: Dec. 8, 2016

(54) DEVICE FOR CONVERTING RADIOFREQUENCY ENERGY INTO DC CURRENT (RECTIFIER ANTENNA) AND CORRESPONDING SENSOR

(71) Applicant: INSTITUT MINES TELECOM, Brest Cedex 3 (FR)

(72) Inventors: Veronique Kuhn, Plouzane (FR); Fabrice Seguin, Morlaix (FR); Cyril Lahuec, Lampaul Plouarzel (FR); Christian Person, Saint-Renan (FR)

(73) Assignee: Institut Mines Telecom, Brest Cedex 3 (FR)

(21) Appl. No.: 15/119,043

(22) PCT Filed: Feb. 12, 2015
(86) PCT No.: PCT/EP2015/053031

§ 371 Date: Aug. 15, 2016

(30) Foreign Application Priority Data
Feb. 14, 2014 (FR) 1451192

(51) Int. Cl. H02J 50/27; G01D 11/00; H02M 7/10

(52) U.S. Cl. CPC H02J 50/27; H02M 7/10; G01D 11/00

(57) ABSTRACT

A device for converting radio-frequency energy into DC current, receiving at least one radio-frequency signal at input and generating at output a DC current capable of powering at least one load. The device has at least two conversion stages, each including: a radio-frequency filtering module, connected to a first input node of the conversion stage, configured to filter the radio-frequency signal; a voltage shift module, connected between a second input node of the conversion stage, the radio-frequency filtering module and an intermediate node of the conversion stage, configured to shift a voltage present at the first input node to the intermediate node; a voltage rectifier module, connected between the intermediate note, the second input node and an output node of the conversion stage, configured to rectify the voltage of the intermediate node and deliver a rectified voltage on the output node.

### 1. CROSS-REFERENCE TO RELATED APPLICATIONS

This application is a Section 371 National Stage application of International Application No. PCT/EP2015/053031, filed Feb. 12, 2015, the content of which is incorporated herein by reference in its entirety, and published as WO 2015/121388 on Aug. 20, 2015, not in English.

### 2. FIELD OF THE INVENTION

The field of the invention is that of the harvesting (retrieval) of energy.

More specifically, the invention relates to a technique for converting radio-frequency energy into DC current or into DC voltage in order to power, for example, electronic circuits.

The invention can be applied especially in the field of power supplies for wired or wireless sensors, for example, in the field of textiles (sensors carried on clothing), medicine (biomedical implants, cardiac stimulators, thermometers, etc.), weather forecasting (remote weather stations, thermometers, etc.), sports (heart rate meters, acceleration meters, oxygen meters, etc.), radio-frequency identification (RFID), mobile telephony (battery recharging, etc.), monitoring, etc.

### 3. PRIOR ART

Lower power consumption by electronic components has led to an increase in mobile applications such as wireless sensors. Most of these sensors or wireless sensor networks (WSN), such as those carried by individuals (known as body sensor area networks or BSANs), are powered by cells/batteries. RFID wireless sensors which are most commonly used consume tens of microwatts in sleep mode and several hundreds of microwatts in active mode.

Even if major progress has been seen in recent years, batteries still have a limited service life and using them raises problems in terms of their accessibility and constraints on their volume (especially for subcutaneous medical implants).

It is therefore sought to explore other alternatives to power these sensors, for example by harvesting the energy available in the surrounding environment. Thus, heat gradients, mechanical vibrations, light waves or radio-frequency waves especially are potential sources of energy for powering these sensors.

In particular, radio-frequency sources have the advantage of being present everywhere in daily life, especially in urban surroundings. Indeed, a multitude of wireless communications standards has led to the proliferation of radio transmitters such as GSM (900 MHz, 1800 MHz), UMTS (2.1 GHz) and WiFi (2.4 GHz) transmitters. These radio-frequency energies, transmitted continuously by telecommunications networks, are therefore being made available on a wide range of frequencies.

The purpose of radio-frequency energy harvesting is to convert the energy coming from ambient radio-frequency sources into DC voltage and DC current. The basic element that ensures this conversion is called a RF-DC converter, a rectifying antenna or again a rectenna.

FIG. 1 is thus a schematic drawing of a radio-frequency energy harvesting device.

According to this schematic drawing, radio-frequency waves 11 are received by a reception antenna 12 and then converted into DC voltage and DC current by an RF-DC converter 13. The current thus generated can be used to power a load 14 which represents, for example, a sensor to be powered.

More specifically, the RF-DC converter 13 comprises an input filter 131, also called a radio-frequency (RF) filter or a high frequency (HF) filter, a rectifier 132 and an output filter 133, also called a DC filter. The input filter 131 is placed between the reception antenna 12 and the rectifier 132. This is a low-pass filter used to block undesirable harmonics. Several types of rectifiers can be envisaged depending chiefly on the incident power and the frequency. In order make the right choice of topology, a compromise must be obtained between the output load voltage and the conversion efficiency, as described in the document “A multi-tone RF energy harvester in body sensor area network context” by V. Kuhn, F. Seguin, C. Lahuec and C. Person, IEEE LAPC conference, Loughborough, November 2013.

Several types of RF-DC converters have been proposed, adapted to receiving radio-frequency energy on one or more frequency bands.

Thus, especially radio-frequency energy harvesting circuits have been proposed for harvesting the radio-frequency energy transmitted on a single frequency band, by using a single rectenna.

It can be noted however that the function of such a rectenna is considerably impaired if the operating frequency has been modified relative to the optimal resonance frequency. Thus, one drawback of these circuits for harvesting radio-frequency energy transmitted in a single frequency band, implementing a single rectenna, is that they are not suited to the ambient environment in which the predominant frequencies differ according to the place of use of the load (for example according to the place of the sensor).

Circuits have also been proposed for harvesting radio-frequency energy transmitted in several frequency bands. Indeed, it has been shown especially that when several sources of radio-frequency energy emitting in different frequency bands are available in the surrounding environment, the quantity of energy harvested can be increased. Thus, as shown in FIG. 2, rectenna networks have been proposed wherein several rectennas (working at different frequencies) are placed in parallel. The DC outputs of each rectenna are added 15 to one another so as to increase the power harvested.

One drawback of these circuits for harvesting radio-frequency energy transmitted in several frequency bands, implementing several rectennas in parallel, is that they require a summing of the DC voltages contributed by each frequency band. Now, if this summing is not properly done it can drastically impair the efficiency of the circuit.

Several techniques have been proposed to implement this kind of summing of the DC voltages, using serial or differential topologies of interconnection.

The serial association of rectifiers to achieve the summing, according to a first structure illustrated in FIG. 3A, can give RF/DC conversion efficiency greater than that of a single frequency band circuit. This is possible only if each arm of the structure is operating, i.e. if the radio-frequency signals are received and processed on each arm of the structure. Indeed, if one of the frequencies is not present in the dedicated arm, this arm is seen as a load for the rest of the circuit. It thus impairs the overall performance of the circuit.

The use of Greinacher-type rectifiers to carry out the summing, according to a second structure illustrated in FIG. 3B, makes it possible to add up the DC outputs without any interference between these different outputs. Indeed, the output of each rectifier is differential. By contrast, one drawback of such a structure is that it requires minimum incident power of −10 dBm for an architecture implementing two Greinacher-type rectifiers. Now, in an urban environment, the average power density of the frequency bands is lower, i.e. lower than −10 dBm. Thus, this type of architecture is not suited to converting energy coming from ambient radio-frequency sources into DC current for the powering of loads.

There is therefore a need for a novel circuit for harvesting radio-frequency energy transmitted in one or more frequency bands that does not have these drawbacks of the prior art.

### 4. SUMMARY OF THE INVENTION

An exemplary embodiment of the present invention proposes a novel solution that does not have all these drawbacks of the prior art in the form of a device for converting radio-frequency energy into DC current, receiving at least one radio-frequency signal at input and generating at output a DC current capable of powering at least one load.

According to the invention, such a conversion device comprises at least two conversion stages, each comprising:
a radio-frequency filtering module, connected to a first input node of said conversion stage, configured to filter one of said at least one radio-frequency signal;
a voltage shift module, connected between a second input node of said conversion stage, said radio-frequency filtering module and an intermediate node of said conversion stage, configured to shift a voltage present at said first input node to said intermediate node;
a voltage rectifier module, connected between said intermediate note, said second input node and an output node of said conversion stage, configured to rectify the voltage of said intermediate node and deliver a rectified voltage on said output node.

In addition, for the first conversion stage, the second input node is connected to a reference voltage and, for a higher conversion stage (second, third, etc.), the second input node is connected to the output node of a lower conversion stage.

Finally, the DC current is generated on the output node of the last conversion stage.

The invention thus proposes a novel device for harvesting radio-frequency energy, used especially to power electronic devices such as sensors.

In particular, the conversion device of the invention comprises several conversion stages. It is adapted to harvesting the radio-frequency energy transmitted in a single frequency band, by activating a single conversion stage (or if a single conversion stage is available), and to harvesting the radio-frequency energy transmitted in several frequency bands by activating several conversion stages, one per frequency band. It can be noted that the number of conversion stages is not limited.

When several conversion stages are activated the proposed conversion device makes it possible especially to provide for efficient summing of the DC voltages contributed by each frequency band present. In particular, the proposed structure enables the adding up of the DC outputs of each conversion stage without any interference between these outputs, even when certain stages are not active, i.e. when these stages do not receive any radio-frequency signal.

In addition, the conversion device according to the invention requires lower incident power than do the prior art devices in order to be able to generate a DC current (or in an equivalent way, DC voltage) capable of powering of at least one load.

According to one particular embodiment of the invention, the voltage shift module uses a first capacitor, connected between the filtering module and the intermediate node, and a first diode, forwardly connected between the second input node and the intermediate node. The voltage rectifier module implements a second capacitor, connected between the second input node and the output node, and a second diode, forwardly connected between the intermediate node and the output node.

Thus, each conversion stage implements two inverse-parallel-connected diodes. Hence, to be able to generate a DC current capable of powering at least one load, it is enough to have available power sufficient to cross the threshold of one diode. By way of a comparison, the use of Greinacher-type rectifiers to harvest the radio-frequency energy transmitted in several frequency bands relies on the use of several series-connected diodes, requiring far greater incident power to start the circuit.

The conversion device according to the invention therefore works with lower incident power values than do the prior art devices.

In addition, the conversion device according to the invention relies on the use of half as many components as those used in the prior art devices, thus entailing lower production costs.

According to one particular aspect of the invention, the components (diodes and capacitors) are surface-mounted components (SMCs). A device for converting energy according to the invention is therefore easy to make and/or easy to detect.

According to one variant, these components can be integrated components.

Such a conversion device therefore takes the form of an electronic circuit which can be printed, integrated, etc.

According to another particular characteristic of the invention, the first and second diodes have approximately identical values.

Thus, within the same conversion stage, the two inverse-parallel-connected diodes have roughly identical threshold voltages. This gives a symmetry at the level of a conversion stage, optimizing the rectification.

According to one variant, the diodes within a same conversion stage, or within different conversations stages, have different threshold voltages.

For example, the first and second diodes are Schottky diodes.

Such diodes used prevent the appearance of parasitic or unwanted capacitances. Naturally, any type of diode having a low threshold voltage can be used (for example a PN junction diode, etc.).

According to one particular characteristic of the invention, the conversion device comprises at least one reception antenna for receiving the radio-frequency signal or signals.

Such a device can indeed be used to harvest the radio-frequency energy conveyed in the ambient air.

For example, the conversion device comprises a single wide-band reception antenna.

Thus, the invention provides a more compact structure which is nevertheless adapted to the reception of radio-frequency signals available in several frequency bands.

According to one variant, the reception device comprises a distinct reception antenna for each conversion stage, each reception antenna being adapted to receiving a radio-frequency signal in a given frequency band. In this case, each reception antenna can have a narrow band.

For example, the radio-frequency filtering module comprises a radio-frequency filter belonging to the group comprising:
a bandpass filter centered on the 900 MHz frequency;
a bandpass filter centered on the 1800 MHz frequency;
a bandpass filter centered on the 2.1 GHz frequency;
a bandpass filter centered on the 2.4 GHz frequency.

Such a conversion device is thus suited to receiving the GSM 900 MHz and/or GSM 1800 MHz and/or UMTS and/or WiFi frequency bands.

Naturally, other frequency bands (from very low frequencies to very high frequencies) can be listened to in order to harvest radio-frequency energy from one or more radio-frequency signals.

According to another embodiment of the invention, the radio-frequency signal or signals are received via a wired link.

The presence of reception antennas is therefore optional. In this case, the radio-frequency signal or signals can be picked up directly at source. For example the source can be a decoding box of the Livebox (registered mark) type. The energy conversion device according to the invention can be directly connected to this decoding box by a wired link.

The invention also relates to a sensor comprising means for collecting data and means for rendering collected data. According to the invention, such a sensor also has a device for converting radio-frequency energy into DC current as described above, receiving at input at least one radio-frequency signal and generating at output DC current powering this sensor.

Such a sensor could of course comprise the different characteristics of the device for converting radio-frequency energy into DC current according to the invention. These characteristics can be combined or taken in isolation. Thus, the characteristics and advantages of this sensor are the same as those of the conversion device and are not described in greater detail.

### 5. LIST OF FIGURES

Other characteristics and advantages of the invention shall appear more clearly from the following description of a particular embodiment, given by way of a simple illustratory and non-exhaustive example, and from the appended drawings, of which:

FIG. 1, described with reference to the prior art, presents a schematic drawing of a device for harvesting radio-frequency energy;

FIG. 2, also described with reference to the prior art, illustrates the harvesting of energy on several frequency bands;

FIGS. 3A and 3B present two examples of RF-DC converters used to harvest energy on several frequency bands according to the prior art;

FIG. 4 illustrates the general principle of a device for converting radio-frequency energy into DC current according to the invention;

FIGS. 5 and 6 present two examples of conversion devices for converting radio-frequency energy according one embodiment of the invention;

FIGS. 7 and 8 illustrate the performance values of the invention;

FIG. 9 illustrates an example of a sensor powered by a device for converting radio-frequency energy into DC current according to one embodiment of the invention.

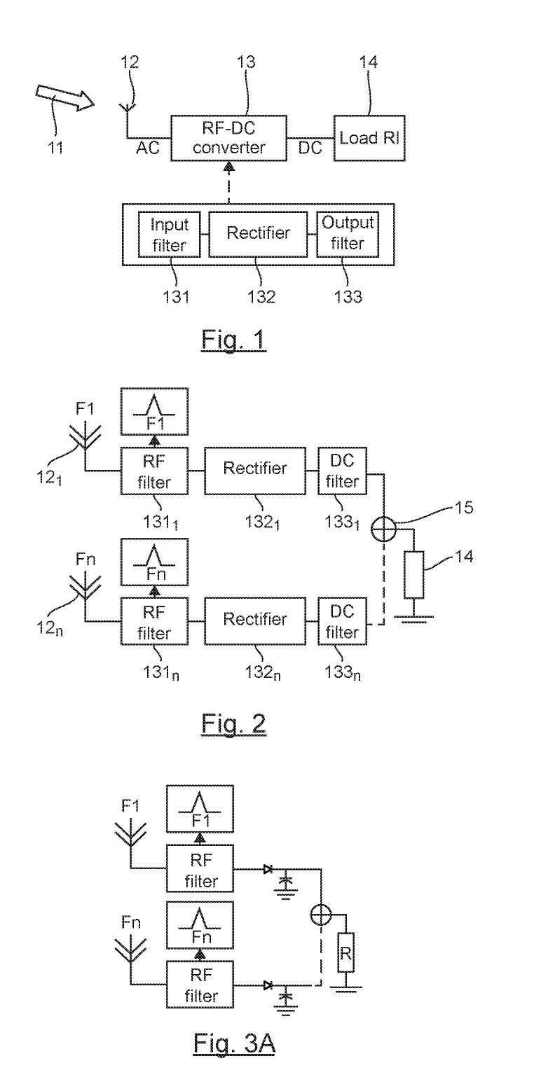

### 6. DESCRIPTION OF ONE EMBODIMENT OF THE INVENTION

### 6.1 General Principle of the Invention

The general principle of the invention relies on a novel device for converting radio-frequency energy into DC current (and in an equivalent way into direct voltage), receiving at input at least one radio-frequency signal and generating at output DC current capable of powering at least one load.

The particular structure of the device according to the invention is used especially to harvest the radio-frequency energy present on one or more frequency bands and to provide for an efficient summing of the DC voltages when radio-frequency energy is harvested on several frequency bands.

In particular, the proposed device is formed by one or more conversion stages each capable of processing a radio-frequency signal received on a distinct frequency band. The differential output of each conversion stage enables a lossless summing of the DC voltages generated.

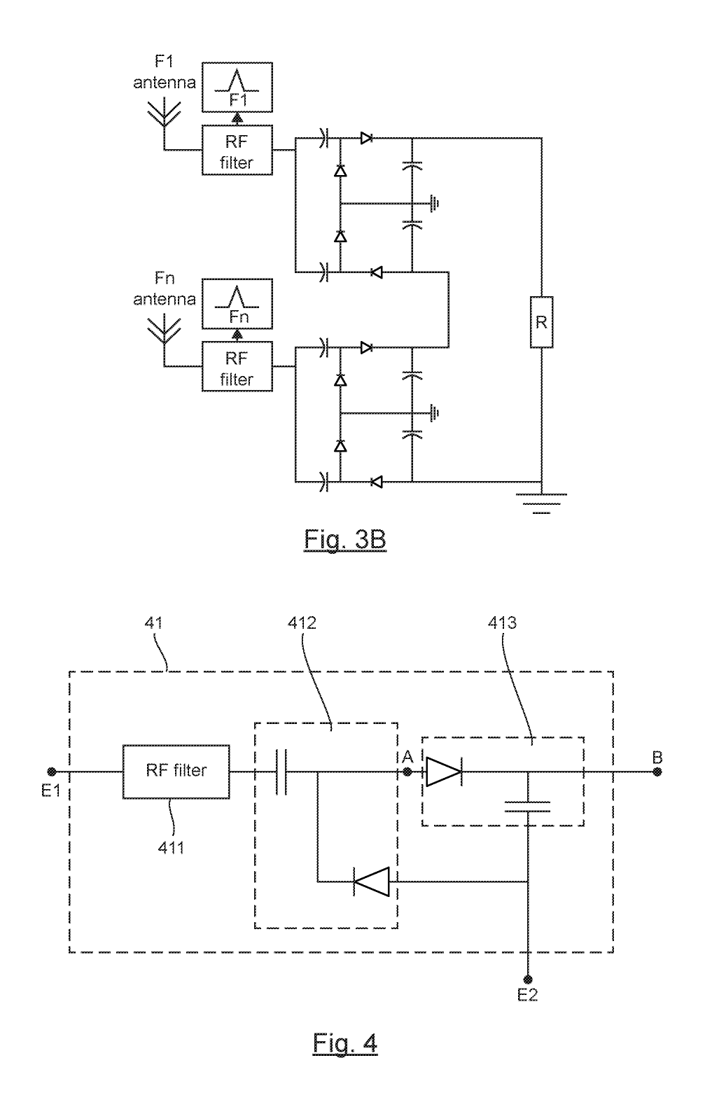

FIG. 4 more specifically illustrates the general principle of a conversion device according to the invention, in the form of an electronic circuit.

Such a conversion device comprises at least two conversion stages 41 each comprising:
a radio-frequency filtering module 411, connected to a first input node E1 of the conversion stage 41, configured to filter a radio-frequency signal. Such a filtering module 411 comprises for example a bandpass filter centered on the frequency F1. It is used to transmit maximum power to the rest of the circuit in the desired frequency band and to block undesirable harmonics to enable optimal conversion efficiency.
a voltage shift module 412 connected between a second input node E2 of the conversion stage 41, the radio-frequency filtering module 411 and an intermediate node A, configured to shift a voltage present in the first input node E1 to the intermediate node A of the conversion stage 41;
a voltage rectifier module 413 connected between the intermediate node A, the second input node E2 and an output node B configured to rectify the voltage of the intermediate node A and to deliver a rectified voltage at the output node B of the conversion stage 41.

In particular, it can be noted that the second input node E2 is connected either to a reference voltage or to the output node of another conversion stage.

When the device has several conversion stages, the second input node E2 of the first stage is connected to a reference voltage, for example to ground or to a 1V reference, and the second input nodes E2 of the other stages are connected to the output nodes B of the lower stages (the second input node of the second stage is connected to the output node of the first stage, the second input node of the i-th stage is connected to the output node of the (i−1)-th stage, etc).

In addition, the DC current capable of powering at least one load is generated at the output node B of the conversion stage if this output node is not connected to a second input node of another conversion stage. In other words, the DC current is generated on the output node of a conversion stage that is not connected to a second input node of another conversion stage.

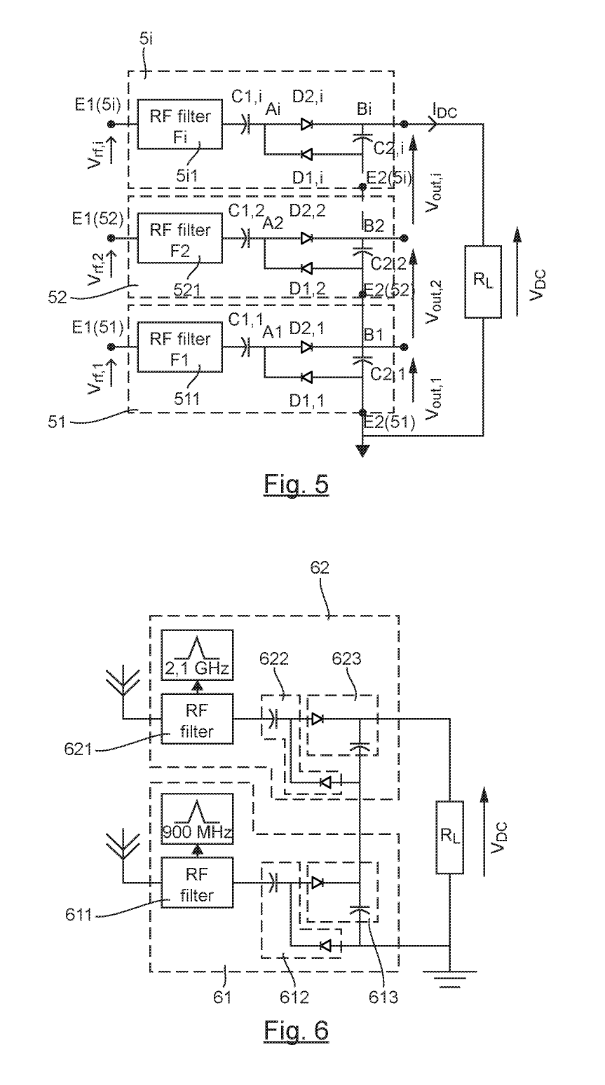

FIG. 5 illustrates the architecture of the proposed solution for a conversion device comprising i conversion stages referenced 51, 52 and 5i.

Each conversion stage is formed by a filtering module, a voltage shift module and a voltage rectifier module as described above.

The conversion device illustrated in FIG. 5 is used to generate DC current I_{DC} used to power a load R_{L}, connected between the output node Bi of the i-th conversion stage 5i and the second input node E2(51) of the first conversion stage 51, which is connected to ground.

More specifically, the first conversion stage 51 comprises two input nodes E1(51) and E2(51), one intermediate node A1 and one output node B1. The second input node E2(51) is connected to a reference voltage, for example ground. This first conversion stage 51 comprises a first filtering module 511, centered on the frequency F1. If V_{rf,1} denotes the AC voltage induced at the first input node E1(51), at input of the filtering module 511, then the voltage shift module, comprising the first capacitor C1,1 and the first diode D1,1, shifts the voltage V_{rf,i} to the intermediate node A1. Thereafter, the voltage rectifier module, comprising the first capacitor C2,1 and the second diode D2,1, rectifies the voltage at the intermediate node A1 to obtain a DC voltage at the output node B1, denoted V_{out,1}.

The second conversion stage 52 comprises two input nodes E1(52) and E2(52), one intermediate node A2 and one output node B2. The second input node E2(52) is connected to the output node B1 of the first conversion stage 51. This second conversion stage 52 comprises a second filtering module 521 centered on the frequency F2. If V_{rf,2} denotes the AC voltage induced at the first input node E1(52), at input of the filtering module 521, then the voltage shift module, comprising the first capacitor C1,2 and the first diode D1,2, shifts the voltage V_{rf,2} to the intermediate node A2. Thereafter, the voltage rectifier module, comprising the second capacitor C2,2 and the second diode D2,2, rectifies the voltage at the intermediate node A2 to obtain a DC voltage at the output node B2 denoted V_{out,2}.

The i-th conversion stage 5i comprises two input nodes E1(5i) and E2(5i), one intermediate node Ai and one output node Bi. The second input node E2(5i) is connected to the output node B(i−1) of the conversion stage (i−1). This i-th conversion stage 5i comprises an i-th filtering module 5i1 centered on the frequency Fi. If V_{rf,i} denotes the AC voltage induced at the first input node E1(5i), at the input of the filtering module 5i1, then the voltage shift module, comprising the first capacitor C1,i and the first diode D1,i, shifts the voltage V_{rf,i} to the intermediate node Ai. Thereafter, the voltage rectifier module, comprising the second capacitor C2,i and the second diode D2,i, rectifies the voltage at the intermediate node Ai to obtain a DC voltage at the output node Bi, denoted as V_{out,i}.

According to the proposed example, the first conversion stage 51 is referenced to ground (second input node E2(51) connected to ground) and the i-th conversion stage 5i is referenced relative to the (i−1)-th conversion stage (second input node E2(5i) connected to the output node of the conversion stage (i−1)).

Each conversion stage therefore forms a rectifier antenna or rectenna.

It can be noted that the first input nodes E1(51), E1(52), E1(5i) of each conversion stage can each be connected to one distinct reception antenna, capable of receiving a radio-frequency signal in the frequency band associated with the conversion stage considered. As a variant, the first input nodes E1(51), E1(52), E1(5i) of each conversion stage can be connected to a single antenna, for example to a wide-band antenna, capable of receiving radio-frequency signals in frequency bands associated with the different conversion stages. It is thus possible to define a structure more compact than a structure that relies on the use of several “directional” reception antennas each adapted to one specific frequency band. According to yet another variant, the first input nodes E1(51), E1(52), E1(5i) are directly connected (by wired links for example) to one or more sources generating a radio-frequency signal.

In particular, it can be noted that if one or more conversion stages are not powered by a voltage V_{rf,i}, these stages will not disturb the other conversion stages powered by a voltage V_{rf,i} through the differential output V_{out,i} of each conversion stage and second capacitors C2i which maintain the DC level.

The DC current I_{DC} is generated on the output node Bi of the conversion stage i, since the output node Bi is not connected to a second input node of another conversion stage. The total voltage obtained V_{DC} is the sum of the contributions V_{out,i} of the different conversion stages, as shown below.

The technical solution proposed therefore provides for a wide-band system and enables the addition of the DC voltages obtained for each frequency band without loss of voltage at output, with a low incident power of the order of −30 dBm. Indeed, the invention requires half as many diodes as in the case of a Greinacher-type rectifier. In addition, it must be noted that the number of frequency bands, i.e. the number of conversion stages is not limited.

### 6.2 Analytic Expression of the Proposed Solution

Here below, the analytic expression of the proposed solution is presented. This analytic expression is used especially to show that the total voltage obtained V_{DC} is the sum of the contributions V_{out,i} of the different conversion stages.

To this end, each conversion stage is considered to be formed by a filtering module, a voltage shift module comprising a first capacitor and a first diode, and a voltage rectifier module comprising a second capacitor and a second diode.

It is assumed that the capacitors of the conversion device are perfect and that their operation is ideal: they let through radio-frequency signals and block DC current.

It is also assumed that the diodes of the same stage have similar threshold voltages and are Schottky-type diodes, modeled by an exponential relationship.

The current I_{d} in the diodes is then written as:

$${I}_{d} = {I}_{s} ( exp ( \frac{{V}_{diode}}{{V}_{T}} - 1 ) ) \qquad ( 1 )$$

with:

Iₛ a constant specific to the type of diode considered;

V_{T} the threshold voltage of the diode considered;

V_{diode} the voltage at the terminals of the diode considered.

In the equation (1), the term V_{diode} represents the voltage at the terminals of each diode which can be written as follows:

V_{diode}=V_{applied}+V_{rf}=V_{applied}+|V_{rf}| cos(ωt) (2)

The voltage V_{applied} applied to the diode in taking account of the series resistance R_{S} of the diode can be expressed as follows:

V_{applied}=Vₚₒₗₐ−R_{S}I_{DC} (3).

It is assumed that the capacitances Ci act as decoupling capacitances: they prevent the DC current from circulating and have little effect on the incident wave of amplitude V_{rf,i} present at the input of each conversion stage, also called an input voltage.

If all the diodes are identical, their static bias Vₚₒₗₐ is computed as a function of the DC voltage of the previous conversion stage.

We thus have:

Vₚₒₗₐ=−½(V_{out,i-1}−v_{out,i}) (4)

V_{diode,i}=−V_{out,i-1}−RₛI_{DC}+|V_{rf,i}| cos(ωt) (5)

The computation of the current flowing through each diode can be done through the Bessel functions which enable the development of the exponential term:

exp(x cos(ωt))=B₀(x)+2ΣBₙ(x)cos(nωt) (6)

Thus, it is possible to isolate the direct term of the current flowing through the diodes:

$${I}_{d} = {I}_{s} ( exp ( \frac{{V}_{diode , i}}{{V}_{T}} - 1 ) ) \\ {I}_{d} = {I}_{s} ( exp ( \frac{{V}_{applied}}{{V}_{T}} ) exp ( \frac{\vert {V}_{rf , i} \vert cos ( ω t )}{{V}_{T}} ) - 1 ) \\ {I}_{d} = {I}_{s} ( exp ( \frac{{V}_{applied}}{{V}_{T}} ) ( {B}_{0} ( \frac{\vert {V}_{rf , i} \vert}{{V}_{T}} ) + 2 \sum {B}_{n} ( \frac{\vert {V}_{rf , i} \vert}{{V}_{T}} ) cos ( ω t ) ) - 1 ) \qquad ( 7 )$$

Thus we have:

$${I}_{D C} = {I}_{s} ( exp ( \frac{{V}_{applied}}{{V}_{T}} ) ( {B}_{0} ( \frac{\vert {V}_{rf , i} \vert}{{V}_{T}} ) ) - 1 ) \qquad ( 8 )$$

Moreover, the following approximate function can be used for B₀:

$${B}_{0} ( x ) = \frac{exp ( x )}{\sqrt{2 π x}} \qquad ( 9 )$$

We thus obtain the following expression for the current I_{DC}:

$${I}_{D C} \approx {I}_{s} ( exp ( \frac{{V}_{applied}}{{V}_{T}} ) \frac{exp ( \frac{\vert {V}_{rf , i} \vert}{{V}_{T}} )}{\sqrt{2 π \frac{\vert {V}_{rf , i} \vert}{{V}_{T}}}} ) \qquad ( 10 )$$

The equation (10) gives a relationship between the point of bias at output of the conversion device and the amplitudes of the incident voltages |V_{rf,i}|:

$$\frac{\vert {V}_{rf , i} \vert}{{V}_{T}} = \frac{ln ( 2 π \frac{\vert {V}_{rf , i} \vert}{{V}_{T}} )}{2} + ln ( \frac{{I}_{D C}}{{I}_{s}} ) - \frac{{V}_{pola}}{{V}_{T}} + \frac{{R}_{s} {I}_{D C}}{{V}_{T}} \qquad ( 11 )$$

Thus:

$$\vert {V}_{rf , i} \vert - \frac{{V}_{T} ln ( 2 π \frac{\vert {V}_{rf , i} \vert}{{V}_{T}} )}{2} - {V}_{T} ln ( \frac{{I}_{D C}}{{I}_{s}} ) - \frac{1}{2} ( {V}_{out , i - 1} - {V}_{out , i} ) + {R}_{s} {I}_{D C} \qquad ( 12 )$$

whence:

$$\frac{{V}_{out , i}}{2} + {V}_{T} ln ( \frac{{V}_{out , i}}{{R}_{L} {I}_{s}} ) + \frac{{R}_{s} {V}_{out , i}}{{R}_{L}} = \frac{1}{2} {V}_{out , i - 1} + \vert {V}_{rf , i} \vert - \frac{{V}_{T} ln ( 2 π \frac{\vert {V}_{rf , i} \vert}{{V}_{T}} )}{2} \qquad ( 13 )$$

The equation (13) is the analytic expression that describes the behavior of the conversion device. Indeed, it relates the parameters of the diode and the output DC voltage V_{out,i-1} to the amplitude of the input voltage V_{rf,i} of the i-th conversion stage. This expression confirms that the DC outputs of the different conversion stages (i.e. the different rectennas) are correctly summed.

### 6.3 Results of Simulation

The implementing of conversion devices comprising either one conversion stage or two conversion stages or three conversion stages has been simulated. The following table presents the voltages applied at input/obtained at output at the different nodes of the conversion device, on the basis of the notations of FIG. 5:

| Number of | Vrf,1 | Vrf,2 | Vrf,3 | Vout,1 | Vout,2 | Vout,3 | V_{DC} |
|---|---|---|---|---|---|---|---|
| stages | (V) | (V) | (V) | (V) | (V) | (V) | (V) |
| 1 | 0.65 | | | 0.86 | | | 0.86 |
| 2 | 0.6 | 0.6 | | 0.75 | 0.73 | | 1.475 |
| 3 | 0.55 | 0.55 | 0.55 | 0.5 | 0.8 | 0.6 | 1.9 |

It can be seen that for a conversion device comprising two conversion stages each powered by the same input voltage (Vrf,1=Vrf,2) the total output voltage V_{DC} is twice as great as the output voltage of the first conversion stage V_{out,1}.

FIG. 6 more specifically illustrates an example of an electrical circuit for the simulation of the conversion of radio-frequency energy conveyed in two distinct frequency bands. The device for converting radio-frequency energy into DC current illustrated in FIG. 6 therefore comprises two conversion stages. For example, the first conversion stage 61 comprises a radio-frequency filter 611 centered on the 0.9 GHz frequency, enabling the harvesting of energy emitted in the GSM900 band, a voltage shift module 612, comprising a first capacitor C1,1 and a first diode D1,1, and a voltage rectifier module 613, comprising a second capacitor C2,1 and a second diode D2,1. The second conversion stage 62 comprises a radio-frequency filter 621 centered on the 2.1 GHz frequency, used to harvest energy emitted in the UMTS 2100 band, a voltage shift module 622, comprising a first capacitor C1,2 and a first diode D1,2, and a voltage rectifier module 623, comprising a second capacitor C2,2 and a second diode D2,2. The values of the diodes and the capacitors can be chosen as a function of the load to be powered. For example, the diodes D1,1, D2,1, D2,1 and D2,2 have a threshold voltage of the order of 150 mV and the capacitors have a value of the order of 15 pF for the first capacitors C1,1 and C1,2 and 68 pF for the second capacitors C2,1 and C2,2.

FIG. 7 illustrates the output voltage V_{DC} obtained at output of the conversion device of FIG. 6 as a function of the incident power Pin when:
only the first conversion stage 61 is activated (i.e. when a radio-frequency signal is received only in the frequency band around the 0.9 GHz center frequency), curve 71:
only the second conversion stage 62 is activated (i.e. when a radio-frequency signal is received only in the frequency band around the 2.1 GHz center frequency), curve 72;
the two conversion stages 61 and 62 are activated (i.e. when radio-frequency signals are received in the two frequency bands), curve 73.

When the two stages receive incident power greater than −30 dBm, the output voltage V_{DC} obtained at output of the conversion device is double the output voltage V_{DC} obtained when a single stage receives an incident power greater than −30 dBm (i.e. when only one frequency band is activated).

FIG. 8 illustrates the efficiency of the conversion of radio-frequency into DC current, in percentage, of the conversion device of FIG. 6 as a function of the incident power Pin, when:
only the first conversion stage 61 is activated (i.e. when the radio-frequency signal is received only in the frequency band around the 0.9 GHz center frequency), curve 81;
only the second conversion stage 62 is activated (i.e. when a radio-frequency signal is received only in the frequency band around the 2.1 GHz center frequency), curve 82;
the two conversion stages 61 and 62 are activated (i.e. when radio-frequency signals are received in the two frequency bands), curve 83.

It is observed again that when the two stages receive incident power greater than −30 dBm, the efficiency is twice the efficiency obtained when a single stage receives incident power greater than −30 dBm (i.e. when only one frequency band is activated).

These performance curves confirm that the voltages measured respectively at 0.9 and 2.1 GHz are correctly summed and do not interfere with one another, i.e. that the output of one conversion stage does not interfere with the output of another conversion stage.

For example, if the conversion device according to the invention is situated at 1 m from the radio-frequency sources in operation, the power harvested is of the order of 15 μW. Now, it is possible to compute the incident power at input of the rectifier according to the Friis formula. A total incident power of the order of 50 μW is obtained. Thus, the efficiency of the conversion device according to the invention is of the order of 30% whereas for a single frequency band it is of the order of 15%. A gain in efficiency is thus seen with a conversion device implementing several conversion stages.

The conversion device according to the invention therefore has improved performance as compared with the techniques of the prior are in terms of output DC voltage, efficiency of RF-DC conversion or else minimum power required to start the circuit. In addition, the DC contributions of each frequency bands/conversion stage are not disturbed relative to one another.

In particular, as compared with the Greinacher-type rectifiers of the prior art, the activation of the circuit according to the invention requires minimum power of the order of −30 dBm whereas the rectifiers of the prior art require a minimum power of the order of −10 dBm. Thus, for equivalent power, the conversion efficiency of the circuit according to the invention is six times higher than that of the prior art systems. In addition, the circuit of the invention relies on the use of half as many components as those used in the existing architectures, thus implying lower production costs.

The current I_{DC} generated at output of the conversion device, or in an equivalent way the voltage V_{DC} generated at output of the conversion device, can be used to power a load, for example a temperature sensor.

One of the advantages of the invention therefore lies in the fact that it directly powers electronic devices with the surrounding energy and can be used especially to recharge the cell/battery of an electronic device.

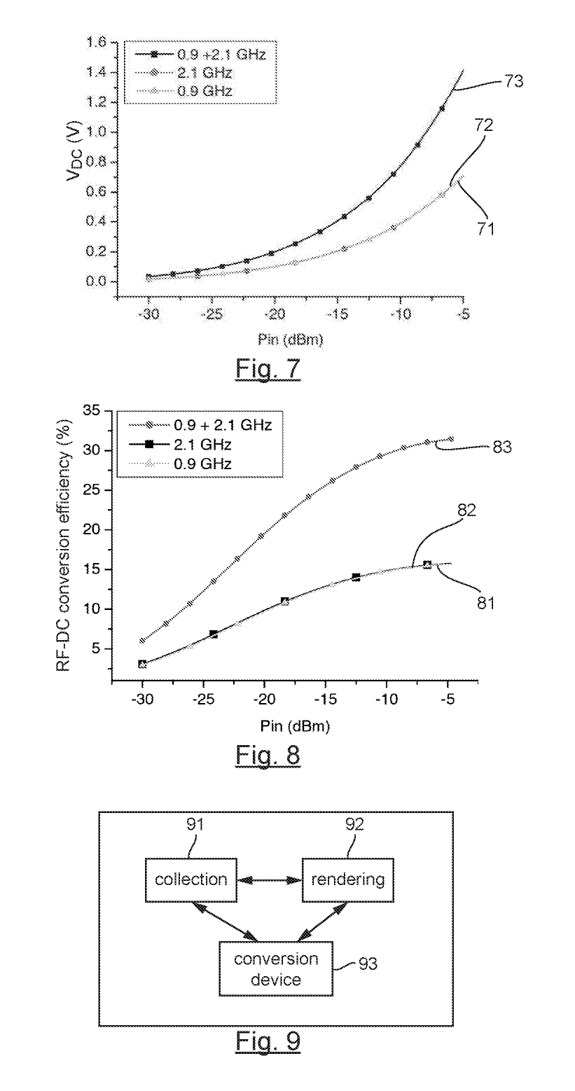

FIG. 9 illustrates an example of an application of the invention for powering a sensor, for example, a thermometer. As illustrated in this figure, such a sensor comprises a data collector for collecting data 91, a data renderer for rendering collected data 92 and a conversion device 93 for converting radio-frequency energy into DC current as described above.

In particular, as already indicated, the invention can be applied especially in the field of providing power to wired sensors or wireless sensors, for example, in textiles, medicine, weather forecasting, sports, radio-frequency identification, telephony, surveillance, etc.

Although the present disclosure has been described with reference to one or more examples, workers skilled in the art will recognize that changes may be made in form and detail without departing from the scope of the disclosure and/or the appended claims.

1. A conversion device for converting radio-frequency energy into DC current, the conversion device comprising:
an input for receiving at least one radio-frequency signal;
an output generating a DC current capable of powering at least one load; and
at least two conversion stages each comprising:
a radio-frequency filtering module, connected to a first input node of said conversion stage, configured to filter one of said at least one radio-frequency signal;
a voltage shift module, connected between a second input node of said conversion stage, said radio-frequency filtering module and an intermediate node of said conversion stage, configured to shift a voltage present at said first input node to said intermediate node;
a voltage rectifier module, connected between said intermediate note, said second input node and an output node of said conversion stage, configured to rectify the voltage of said intermediate node and deliver a rectified voltage on said output node,
wherein, for a first of the at least two conversion stages, said second input node is connected to a reference voltage and, for a higher one of the at least two conversion stages, said second input node is connected to the output node of a lower conversion stage, and
the DC current is generated on the output node of a last of the at least two conversion stages.

2. The conversion device according to claim 1, wherein said voltage shift module implements a first capacitor, connected between said filtering module and said intermediate node, and a first diode, forwardly connected between said second input node and said intermediate node, and said voltage rectifier module implements a second capacitor connected between said second input node and said output node, and a second diode, forwardly connected between said intermediate node and said output node.

3. The conversion device according to claim 2, wherein said first and second diodes and said first and second capacitors are surface-mounted components.

4. The conversion device according to claim 2, wherein said first and second diodes have approximately identical values.

5. The conversion device according to claim 2, wherein said first and second diodes are Schottky diodes.

6. The conversion device according to claim 1, further comprising at least one reception antenna for receiving said at least one radio-frequency signal.

7. The conversion device according to claim 6, wherein said reception antenna is a wide-band antenna.

8. The conversion device according to claim 1, wherein said radio-frequency filtering module comprises a radio-frequency filter belonging to the group consisting of:
a bandpass filter centered on the 900 MHz frequency;
a bandpass filter centered on the 1800 MHz frequency;
a bandpass filter centered on the 2.1 GHz frequency;
a bandpass filter centered on the 2.4 GHz frequency.

9. The conversion device according to claim 1, wherein said at least one radio-frequency signal is received via a wired link.

10. A sensor comprising:
a data collector;
a data renderer, which renders data collected by the data collector; and
a conversion device for converting radio-frequency energy into DC current the conversion device comprising:
an input for receiving at least one radio-frequency signal;
an output generating a DC current capable, which powers the sensor; and
at least two conversion stages each comprising:
a radio-frequency filtering module, connected to a first input node of said conversion stage, configured to filter one of said at least one radio-frequency signal;
a voltage shift module, connected between a second input node of said conversion stage, said radio-frequency filtering module and an intermediate node of said conversion stage, configured to shift a voltage present at said first input node to said intermediate node;
a voltage rectifier module, connected between said intermediate note, said second input node and an output node of said conversion stage, configured to rectify the voltage of said intermediate node and deliver a rectified voltage on said output node,
wherein, for a first of the at least two conversion stages, said second input node is connected to a reference voltage and, for a higher one of the at least two conversion stages, said second input node is connected to the output node of a lower conversion stage, and
the DC current is generated on the output node of a last of the at least two conversion stages.
